(19) United States
(12) Patent Application Publication
(10) Pub. No.: US 2009/0163251 A1
(43) Pub. Date: Jun. 25, 2009

(54) Method and Telephone For Downloading Audio and Video Content For Call Indication

(76) Inventor: Guillaume Decugis, Paris (FR)

Correspondence Address: VIERRA MAGEN/MICROSOFT CORPORATION, 575 MARKET STREET, SUITE 2500, SAN FRANCISCO, CA, 94105, US

(21) Appl. No.: 10/575,880

(22) PCT Filed: Oct. 14, 2004
(86) PCT No.: PCT/FR04/02618

§ 371 Date: Mar. 12, 2007

(30) Foreign Application Priority Data
Oct. 14, 2003 (FR) 0311976

(51) Int. Cl. H04B 1/38; H04M 1/00

(52) U.S. Cl. 455/567; 455/566

(57) ABSTRACT

The invention relates to a method for downloading ring tunes in order to customising mobile telephones which is characterised in that apart of the audio content, downloaded data comprise a graphical animation displayable on a mobile telephone screen when the audio content is played on the telephone during an incoming call reception, and, where appropriate also the audio content being simultaneously downloaded or being pre-downloaded and memorised by the operation layer of the mobile telephone.

### TECHNICAL FIELD

This invention relates to the personalization of mobile phones.

In particular, it is relative to the downloading of ring tones for personalizing mobile phones (ring tones, screens, etc.).

There have been for some time services that allow downloading ring tones to mobile phones, which allow users to customize their telephones.

On old-generation mobile phones, these ring tones were monophonic rings created using MIDI type synthesizers. These MIDI ring tones have since then evolved to become polyphonic.

More recently, mobile phone manufacturers have proposed downloading ring tones that correspond to real sounds, and, for example, ring tones similar to original music (song clips, etc.)

### GENERAL PRESENTATION OF THE INVENTION

The invention itself proposes a new type of processing for personalizing call reception in mobile phones.

In particular, it proposes to complete audio content that can be used as a personalized call ring, with a graphical animation related to this ring tone and that is displayed on the screen in a synchronized or simultaneous fashion with respect to the call ring.

A problem that sometimes occurs is that the architecture of mobile phones is not generally designed to allow triggering the reading of a multimedia object when an incoming call is received.

Indeed, the desire is to be able to have a solution that allows playing back the combination of audio content and graphical content on the telephone when an incoming call is received, even if the telephone does not have an architecture that is adapted to trigger the reading of a multimedia object when an incoming call is received.

The invention itself proposes a method for downloading ring tones for personalizing mobile phones, characterized in that, in addition to an audio content, the downloaded data comprises graphical animation content for being displayed on the screen of the mobile phone when the audio content is played on the phone upon reception of an incoming call, an application for reading graphical animations content, and, if need be also for reading audio content, being simultaneously downloaded or having been downloaded beforehand and stored at the operating layer of the mobile phone.

It also proposes a mobile phone adapted to download ring tone for personalization of mobile phones, characterized in that the operating layer stores an application for reading graphical animations contents, the phone comprising means for triggering the reading of this graphical animations content upon reception of an incoming call.

As it can be understood, the various solutions proposed by the invention can be, particularly and advantageously applied, but not limited to telephones equipped with “symbian” type operating systems (OS) and, in particular, those in which the telephones are equipped with “series 60” type interfaces.

A “symbian” OS is a software component that, for telephones based on this tool, provides, among other things, a set of basic functions, including hardware drivers, a large number of the graphical controls, and memory management functions.

As regards to “Series 60”, this is graphical integrated software (“framework”) created by the company NOKIA, based on a Symbian environment and that provides, among other things, telephone functions and IHM functions.

Other characteristics and advantages of the invention will be further highlighted in the following description, which is provided for illustrative purposes and is non-limiting.

Thus, in a much more general sense, a problem that arises is the triggering of the personalization content upon receipt of an incoming call.

Different aspects of the invention, allowing, in particular, resolving this problem are presented.

1) In particular, a method for enabling the reading of at least one personalization content, such as a graphical content or an audio content, upon reception of an incoming call on the mobile phone, characterized in that a background task application, possibly downloaded in the operating layer of the mobile phone, monitors the notification of an incoming call to the phone server of said layer and activates the reading of the content by the reading application upon the notification of an incoming call.

More specifically, it proposes a method for enabling the substantially synchronous reading of at least an audio content and a graphical content upon reception of an incoming call on the mobile phone, characterized in that a background task application, possibly downloaded in the operating layer of the mobile phone, monitors the notification of an incoming call to the phone server of said layer and activates the reading of the graphical content by the reading application upon the notification of an incoming call.

Additionally, the invention proposes a mobile phone adapted for enabling the reading of at least a personalization content upon reception of an incoming call, characterized in that the phone comprises a background task application, possibly downloaded in the operating layer of the mobile phone, adapted for monitoring the notification of an incoming call to the phone server of said layer and for activating the reading of the graphical content by the reading application upon the notification of an incoming call.

Also, it proposes a mobile phone adapted for enabling the substantially synchronous reading of at least an audio content and a graphical content upon reception of an incoming call, characterized in that the phone comprises a background task application, possibly downloaded in the operating layer of the mobile phone, adapted for monitoring the notification of an incoming call to the phone server of said layer and for activating the reading of the graphical content by the reading application upon the notification of an incoming call.

2) According to another aspect, the invention proposes a method for enabling the reading of at least an animation content upon reception of an incoming call on the mobile phone, characterized in that an application for reading graphical content possibly downloaded in the operating layer of the mobile phone monitors in a background task the activation of a codec and activates the reading of the associated personalization content when said activation codec is detected.

More specifically, a method for enabling the substantially synchronous reading of at least an audio content and a graphical content upon reception of an incoming call, characterized in that an application for reading graphical content possibly downloaded in the operating layer of the mobile phone monitors in a background task the activation of a codec corresponding to the audio content and activates the reading of the associated personalization content when said activation codec is detected.

Additionally, the invention proposes a mobile telephone adapted for enabling the reading of at least a personalization content upon reception of an incoming call, characterized in that the phone comprises an application for reading graphical content possibly downloaded in the operating layer of the mobile phone, adapted for monitoring in a background task the activation of a codec corresponding to the audio content and for activating the reading of the associated personalization content when said activation codec is detected.

3) According to another aspect, the invention proposes a method for enabling the reading of at least a personalization content upon reception of an incoming call on a mobile phone, characterized in that an application for reading the content possibly downloaded in the operating layer of the mobile phone monitors in a background task the notification of an incoming call to an interface phone application or to a phone server of said layer and activates the reading of said content upon notification of an incoming call.

More specifically, a method for enabling the substantially synchronous reading of at least an audio content and a graphical content upon reception of an incoming call on a mobile phone, characterized in that an application for reading the graphical content possibly downloaded in the operating layer of the mobile phone monitors in a background task the notification of an incoming call to an interface phone application or to a phone server of said layer and activates the reading of said content upon notification of an incoming call.

Also, a mobile phone is proposed that is adapted for the reading of at least a personalization content upon reception of an incoming call on a mobile phone, characterized in that the phone comprises an application for reading said content, possibly downloaded in the operating layer of the mobile phone, adapted for monitoring in a background task the notification of an incoming call to an interface phone application or to a phone server of said layer and for activating the reading of said content upon notification of an incoming call.

More specifically, a mobile telephone is proposed that is adapted for enabling the substantially synchronous reading of at least an audio content and a graphical content upon reception of an incoming call on a mobile phone, characterized in that it comprises an application for reading the graphical content possibly downloaded in the operating layer of the mobile phone adapted for monitoring in a background task the notification of an incoming call to an interface phone application or to a phone server of said layer and for activating the reading of said content upon notification of an incoming call.

As an alternative, a codec is declared at the system level. This codec is associated with a type of content and has a file extension.

The downloaded data of this type is automatically associated with this codec, which includes audio content and graphical animation content; a reading application for this type of codec being simultaneously downloaded or previously downloaded and stored in the operating layer of the mobile telephone.

4) According to another aspect of the invention, a method is proposed for activating at least one personalization content upon reception of an incoming call on a mobile phone, characterized in that it comprises the steps consisting in:
downloading at least said content,
automatically placing said content as a favorite intended to be activated upon reception of the next incoming call, this step being performed without intervention of the user in the different configuration menus of the phone.

More specifically, a method is proposed for activating an audio content upon reception of an incoming call on a mobile phone, characterized in that it comprises the steps consisting in:
downloading the audio content and associated graphical animation content,
automatically placing the audio content as a favorite intended to be activated upon reception of the next incoming call, this step being performed without intervention of the user in the different configuration menus of the phone.

Also, a mobile phone is proposed that is adapted for allowing the reading of at least one personalization content upon reception of an incoming call on the mobile phone, characterized in that it comprises an application, which upon downloading of said content, automatically places it as a favorite intended to be activated upon reception of the next incoming call, this step being performed without intervention of the user in the different configuration menus of the phone.

5) According to another aspect of the invention, a method is proposed for personalizing mobile phones, characterized in that it comprises the steps according to which:
a user composes combined content by associating audio content and graphical animation content, from contents already present in the phone or which the user can download otherwise, by means of an interface application stored at the operating layer of the phone,
when the audio content is played on the phone upon reception of an incoming call, an application for reading graphical content animation, and if need be for reading also audio content, reads the graphical animation content.

Additionally, a mobile phone is proposed, characterized in that it comprises an interface application, stored at the operating layer of the phone, adapted for allowing a user to compose combined content by associating audio content and graphical animation content, from contents already present in the phone or which the user can download otherwise, the graphical animation content being intended to be read by a reading application of the phone when the audio content is played on the phone upon reception of an incoming call.

6) According to another aspect of the invention, a method is proposed for allowing the reading of graphical animation content upon reception of an incoming call on a mobile phone, characterized in that it comprises the steps consisting in:
memorizing in the mobile phone graphical animation content as fixed images in native format,
upon reception of an incoming call, displaying in sequence the fixed images in native format according to a parametrizable “frame rate”.

7) Also a mobile phone is proposed that is adapted to allow the reading of graphical animation content upon reception of an incoming call, characterized in that it comprises a reading application adapted for displaying in sequence fixed images in native format according to a parametrizable frame rate upon reception of an incoming call.

According to yet another aspect, a method is proposed for downloading ring tones for personalizing mobile phones, characterized in that it comprises the steps consisting in:
memorizing a file including audio content and/or graphical animation content, in encrypted form, at the operating layer of the phone,
upon reception of an incoming call, decrypting the file in the random access memory and reading the audio content and/or the graphical content.

Also, a mobile telephone is proposed that is adapted for allowing the downloading of ring tones for personalizing mobile phones, characterized in that it comprises means for memorizing a file including audio content and/or graphical animation content, in encrypted form, at the operating layer of the phone, and a reading application adapted, upon reception of an incoming call, for decrypting the file in the random access memory and for reading the audio content and/or the graphical content

8) Also, a method is proposed for downloading and reading animation content, according to which said content is transferred to the phone in a compressed format and said content is stored in the phone in a decompressed format, said content being read in real time under this format upon reception of an incoming call.

### PRESENTATION OF THE DRAWINGS

This description must be read while referencing the attached diagrams, in which:

FIG. 1 illustrates in a simplified manner, an example of the software architecture on a mobile telephone;

FIGS. 2 to 4 illustrate three possible implementation variations of the invention on such architecture.

### DESCRIPTION OF ONE OR SEVERAL EMBODIMENTS AND DETAILED EMBODIMENTS

### General Architecture

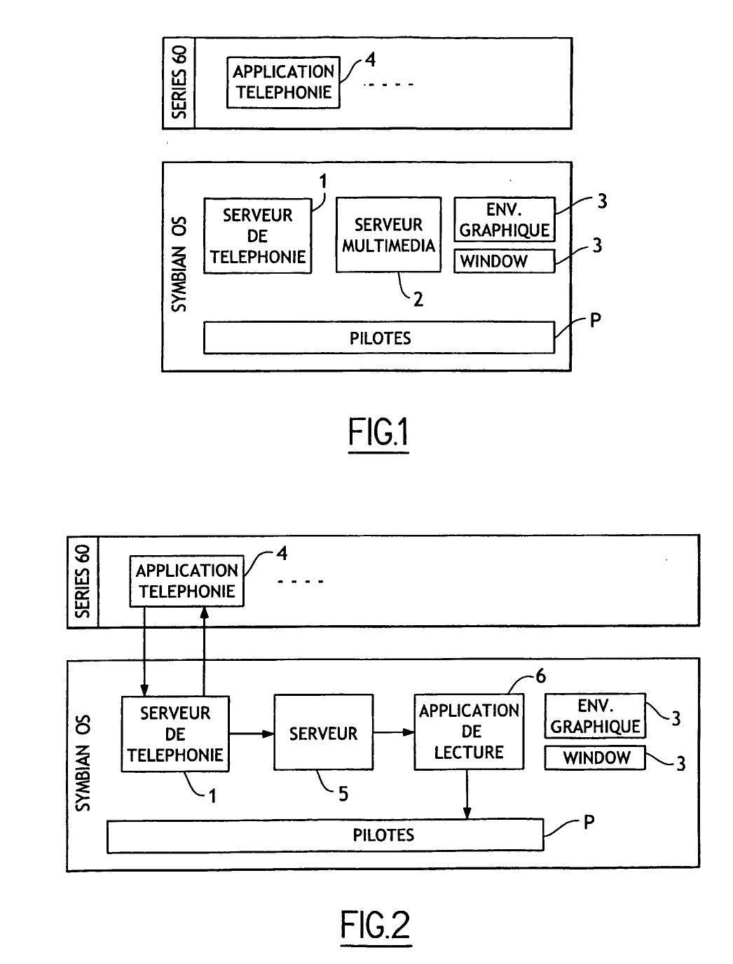

FIG. 1 includes a schematic representation of the software architecture of a mobile phone that includes an operating OS layer and a graphical interface IG application environment, for example, a “Series 60” type environment.

Notably, the operating layer integrates the following:
a telephone server 1 that manages the dialog with the GSM/GPRS protocol stack; this server 1 recovers the events related to calls and distributes them to applications that make the request;
a multimedia server 2 that manages the audio or video codecs (compressed objects);
various graphical applications 3.

The graphical interface IG includes, in particular, a telephone application 4 that is permanently active as a background task and that, in particular, manages the incoming calls and the dialog with the server 1.

### First Variation: Use of a Background Task Server

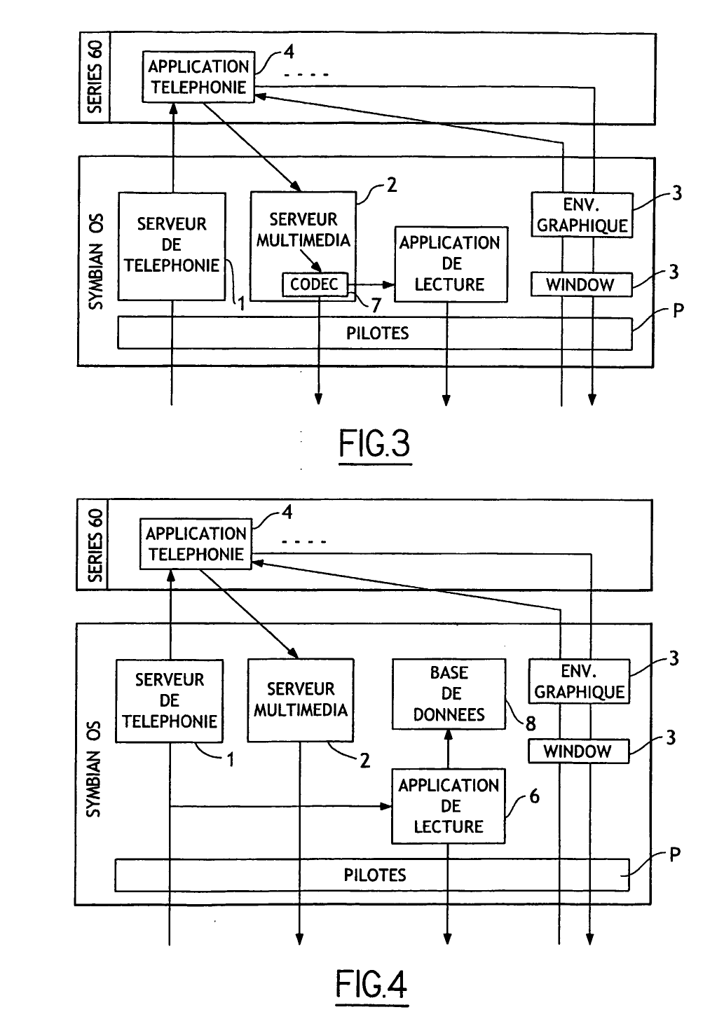

As illustrated in FIG. 2, a background task server 5 can be used, for example, downloaded into the mobile phone, and whose function is to detect the arrival of incoming calls, in parallel to the means that are traditionally mobilized by the mobile telephone for managing said calls.

When this background task server 5 detects an incoming call, it triggers the execution of a graphical animation display, while the ring tone is triggered by means that traditionally intervene in the management of an incoming call of a telephone and, in particular, by the telephone application 4.

The background task server 5 is memorized in the operating layer and monitors the activation of a specific event linked to the arrival of an incoming call, at the level of the telephone server 1.

When it detects this event, the server 5 triggers a reading application 6 (“Player”) that plays back the graphical animation on the screen.

This reading application 6 is also memorized at the operating layer level.

In parallel, the telephone application 4 plays back the melody, the real sound, etc. that corresponds to the personalized ring tone chosen by the user (ring tone to which the graphical animation is associated).

As can now be understood, such background task server architecture allows playing back in parallel in a substantially synchronized way the audio content and the graphical animation content.

The background task server 5 is, for example, downloaded into the mobile telephone when the user connects to a personalization content server and then downloads for the first time audio content and graphical animation content that corresponds to said user.

In this case, the graphical animation content is itself advantageously downloaded with the reading application 6.

It should be noted that in order to directly display the graphical animation 6 even if the architecture of the telephone generally gives high priority to the telephone application when a call comes is, this reading application 5 short-circuits the graphical layers of the telephone in order to directly write into the screen memory.

This way, any possible conflicts between the graphical animation reader and the traditional graphical layers of the graphical software and/or OS of the mobile telephone are avoided.

To avoid command conflicts with the various functions of the telephone that may generate display icons in certain areas of the screen, there will advantageously be specific masks for these zones. Their operation is as follows: The icon is marked at the first display and is reprinted on the back of the animations as soon as it is first “refreshed.” Then, the icon zone is not longer updated, which prevents the icon from being cyclically erased/displayed, and which deletes the unpleasant affect of fast flashing.

This way, the icons that are normally active upon reception of a call or when the mobile telephone is connected to a charger, when the infrared exchange function is activated, etc. are no longer displayed or flashed.

### Second Variation: Activation of a Graphical Content Reading Application by an Audio Code

In the variation illustrated in FIG. 3, a codec is memorized at the multimedia server level, while a reading software application 6 monitors in a background task the activation of this codec. Codecs are associated to a multimedia reader and the content files that correspond to a codes can be selected as ring tones.

By ring tone, in this case and throughout the entire text, it means any melody or real sound and, in general, any audio content designed to be played back during an incoming call to notify the user of this event.

The operating steps are therefore as follows:

The arrival of an incoming call is indicated to the telephone application 4.

The application activates, in a traditional manner, the call presentation screen.

At the same time, the detection of the call by the background task software activates in the multimedia content the selected melody/ring tone.

This activates the codec 7.

The codec 7 activation is detected by the reading application 6 that restores, in parallel, the reading of the audio flow, the graphical flow, until the “unhook/hook” event is recovered.

### Third Variation: Reading Application is Triggered by the Detection of a Call Indication Event

In the variation illustrated in FIG. 4, the reading application 6 monitors in a background task the indication of the incoming call to the telephone application 3.

In this case, when an event indicating an incoming call is detected by this reading application 6, the latter queries the user updates (databases 8 memorized in the operating layer) in order to check whether the selected ring tone corresponds to graphical content, if necessary, it restores the graphical content, which is for example, memorized in the a dedicated area of the “File System” and associated to the multimedia server 3 using a codec.

At the same time, the indication of an incoming call to the application 4 activates the selected melody or ring tone, which is also restored. The audio stream and graphical stream are thus played by until the “unhook/hook” event is recovered.

### Fourth Variation: Use of a Codec That Contains an Animation in Addition to Sound

Another possible variation is to use a codec that contains an animation in addition to sound.

This is in the case of an open operating system that allows, for example, developing and installing a content reader that can also be used in the ring tone configuration menus and that are designed to be dedicated to a type of ring tone content.

If content of this type is selected as a ring tone, this content reader is invoked for each incoming call.

Therefore, it presents no problems in terms of synchronization, no specific development is necessary.

### Downloading Animation Contents

In most current mobile phones, the processor power is not enough to decode standard image containers (gif, png, jpeg, etc.) on the fly.

To overcome this difficulty, proposed is the use of the native image format of the mobile phone or its operating system either directly in the container or by converting a standard format (gif, png, jpeg, etc.) during installation in order to store it in the native format of the mobile phone.

Furthermore, the unavailability of an animated type native format leads to integrating into the reading application (“player”) the capacity to display in sequence fixed images in native format according to a parameterizable “frame rate”.

This second solution has the determining advantage of reducing the size of the downloaded object for installing the multimedia content.

Moreover, also according to another aspect, proposed is the transfer of images to the telephone is a compressed format, then storing them in decompressed mode in order to avoid having to decompress them in real time. This results in a decrease in downloading times as well as a CPU gain during the activation of these images.

### Installation of Ring Tones

Moreover, traditionally, when users install personalization content into their telephone, for example a new ring tone, they must find the convenient configuration menu(s) in their phone, then look for the downloaded file(s) in the location where it/they were downloaded.

In the case of ring tones associated to graphical content, the following difficulties may also present themselves:

Several elements are necessary and it is important that these objects not be downloaded separately but in a single file.

Furthermore, it may be necessary to format the filenames (prefix, suffix, extension, etc.), place them in specific directories, and decompress and/or format them (limitations required by ISO or the framework.)

To resolve these difficulties, the grouping of all the elements necessary for operation during installation is proposed.

Thus, with each download, not only is the audio content and graphical animation content (corresponding to one or several files) transmitted to the telephone, but also the reading application(s).

Advantageously, a configuration file, etc. can also be downloaded at the same time.

This solution provides ease-of-use and comfort for the user and allows operating the audio content combined with the graphical animation content within the telephone's environment.

In a more general manner, this mechanism can be used for all other cases where grouped contents can turn out to be interesting: for example, the following contents can be grouped, Ring tone offer+wallpaper+screensaver.

### Managing Favorites

Also, a new downloaded ring tone could be automatically placed as a favorite designed to be activated during the next incoming call.

This ring tone then replaces the previous favorite.

To do this, the application or content associated to the codec is installed, all the actions necessary to simultaneous activate the sound and graphics are automatically performed without user intervention in the various configuration menus of the telephone.

Furthermore, there can be means for detecting that the user decides to change their favorite ring tone, and block the activation of the corresponding graphical animation when a change of this type is detected.

### Composition by the User

Advantageously, there can be at the level of the operating layer an interface application (if necessary, also downloaded on request by the user or during the first connection) that allows the users compose their own combined contents (graphical animations/ring tone) from content that is already present in their telephone or that they can also download (ring tones, photos, animated gif, voice memos, etc.)

Once assembled, this combined context resembles the context designed for downloading.

Of course, taking photographs and recording sound can also be directly performed using the camera and telephone recorder.

This way, users can personalize their mobile phones using personal elements.

### Content Protection

The use of reading software or a “player” allows implementing a simple mechanism for protecting file contents. The file is encrypted in the container file and decrypted in the random access memory so that malicious users cannot copy the files using a file explorer (“File System”) and use it for purposes that are not within the framework of their utilization license contract and, in particular, sending it to other users that have not purchased the content.

This same mechanism is used to propose a pre-purchase demo module. Thus, users cannot obtain the demo and then use the content for other purposes.

As can be understood, the invention is more specifically described in the case of graphical animation type personalization content. It is applicable, generally, to any personalization content: audio content, screensavers, etc.

1. Method for downloading ring tones for personalizing mobile phones, wherein, in addition to an audio content, the downloaded data comprise a graphical animation content for being displayed on the screen of the mobile phone when le audio content is played on the phone upon reception of an incoming call, an application for reading graphical animations content, and, if need be also for reading audio content, being simultaneously downloaded or having been downloaded beforehand and stored at the operating layer of the mobile phone.

2. Method according to claim 1, wherein the downloaded data comprises a codec which comprises an audio content and a graphical animations content, an application for reading such a type of codec being simultaneously downloaded or having been previously downloaded and memorized at the operating layer of the mobile phone.

3. Method according to claim 1, wherein the downloaded data comprises a codec which comprises an audio content and a codec which comprises a graphical animations content.

4. Method according to claim 1, wherein at each new downloading, the downloaded data comprises an application for reading the graphical animations content and/or audio content.

5. Method according to claim 4, wherein the downloaded data also comprises one or more configuration files.

6. Method according to claim 1, wherein, with the application for reading the graphical content, a background task application is downloaded in the operating layer of the mobile phone, which monitors the notification of an incoming call to a phone server of said layer and activates the reading of the graphical content by the reading application.

7. Method according to claim 1, wherein the reading application downloaded in the operating layer monitors in background task the activation of a codec corresponding to a ring tone which is associated to it, the reading of the graphical animations content being triggered when said coded activation is detected.

8. Method according to claim 1, wherein the reading application downloaded in the operating layer monitors in background task the signalling of a call to an interface phone application or to the phone server of the operating layer, the reading of the graphical animation content being triggered when an event corresponding to this signalling is detected.

9. Method according to claim 1, wherein the reading application bypasses the graphical layers of the phone for writing directly in the screen memory.

10. Method according to claim 9, wherein the reading application uses a mask for not entering into conflict with certain areas for displaying certain icons.

11. Method according to claim 1, wherein the data are downloaded from a container storing graphical animations in a native format of the mobile phone or of its operating system.

12. Method according to claim 1, wherein during the downloading, the data are downloaded while being converted such that the graphical animations are stored in the mobile phone in the native image format of the latter or of its operating system.

13. Method according to claim 1, wherein each new downloaded ring tone is automatically memorized in the mobile phone as a favourite intended to be activated at the next incoming call.

14. Method according to claim 13, wherein the application is installed or the content associated to the codec is activated, all the necessary actions for simultaneous activation of the sound and graphics being done automatically and without intervention of the user in the different configuration menus of the phone.

15. Mobile phone adapted to download ring tone for personalization of mobile phones, wherein the operating layer stores an application for reading graphical animations contents, the phone comprising means for triggering the reading of this graphical animations content upon reception of an incoming call.

16. Phone according to claim 15, wherein the reading application is adapted for reading a codec which comprises an audio content and a graphical animations content.

17. Phone according to claim 15, wherein with the reading application is a background task application which monitors the notification of a call to the phone server of said layer and activates the graphical content reading by the reading application.

18. Phone according to claims 15 or 16, wherein the reading application monitors in background task the activation of a codec corresponding to a ring tone which is associated to it, the reading of the graphical animations content being triggered when said codec activation is detected.

19. Phone according to claims 15 or 16, wherein the reading application monitors, in background task, the signalling of a call to an interface phone application or to the phone server of the operating layer, the reading to the graphical animation content being triggered when an event corresponding to this signalling is detected.

20. Phone according to claim 15, wherein the playing application bypasses the graphical layers of the phone to directly attack the screen memory.

21. Phone according to claim 20, wherein the reading application comprises means for masking certain icons displaying areas of the phone.

22. Phone according to claim 15, comprising means adapted for detecting that the user decides to change his favourite ring tone, and for blocking the activation of the corresponding graphical animation when a change of this type is detected.

23. Phone according to claim 15, comprising an interface application (if need be also downloaded) which allows the user to compose his own combined contents from the content already present on his phone or which he can download otherwise.

24. Method for enabling the reading of at least one personalization content, such as a graphical content or an audio content, upon reception of an incoming call on the mobile phone, wherein a background task application, possibly downloaded in the operating layer of the mobile phone, monitors the notification of an incoming call to the phone server of said layer and activates the reading of the content by the reading application upon the notification of an incoming call.

25. Method for enabling the substantially synchronous reading of at least an audio content and a graphical content upon reception of an incoming call on the mobile phone, characterized in that wherein a background task application, possibly downloaded in the operating layer of the mobile phone, monitors the notification of an incoming call to the phone server of said layer and activates the reading of the graphical content by the reading application content upon the notification of an incoming call.

26. Mobile phone adapted for enabling the reading of at least a personalization content upon reception of an incoming call, wherein the phone comprises a background task application, possibly downloaded in the operating layer of the mobile phone, adapted for monitoring the notification of an incoming call to the phone server of said layer and for activating the reading of the graphical content by the reading application content upon the notification of an incoming call.

27. Mobile phone adapted for enabling the substantially synchronous reading of at least an audio content and a graphical content upon reception of an incoming call, wherein the phone comprises a background task application, possibly downloaded in the operating layer of the mobile phone, adapted for monitoring the notification of an incoming call to the phone server of said layer and for activating the reading of the graphical content by the reading application content upon the notification of an incoming call.

28. Method for enabling the reading at least an animation content upon reception of an incoming call on the mobile phone, wherein an application for reading graphical content possibly downloaded in the operating layer of the mobile phone monitors in background task the activation of a codec and activates the reading of the associated personalization content when said activation codec is detected.

29. Method for enabling the substantially synchronous reading of at least an audio content and a graphical content upon reception of an incoming call, characterized in that wherein an application for reading graphical content possibly downloaded in the operating layer of the mobile phone monitors in background task the activation of a codec corresponding to the audio content and activates the reading of the associated personalization content when said activation codec is detected.

30. Mobile phone adapted for enabling the reading of at least a personalization content upon reception of an incoming call, wherein the phone comprises an application for reading graphical content possibly downloaded in the operating layer of the mobile phone, adapted for monitoring in background task the activation of a codec corresponding to the audio content and for activating the reading of the associated personalization content when said activation codec is detected.

31. Method for enabling the reading of at least a personalization content upon reception of an incoming call on a mobile phone, wherein an application for reading the content possibly downloaded in the operating layer of the mobile phone monitors in background task the notification of an incoming call to an interface phone application or to a phone server of said layer and activates the reading of said content upon notification of an incoming call.

32. Method for enabling the substantially synchronous reading of at least an audio content and a graphical content upon reception of an incoming call on a mobile phone, wherein an application for reading the graphical content possibly downloaded in the operating layer of the mobile phone monitors in background task the notification of an incoming call to an interface phone application or to a phone server of said layer and activates the reading of said content upon notification of an incoming call.

33. Mobile phone adapted for the reading of at least a personalization content upon reception of an incoming call on a mobile phone, wherein the phone comprises an application for reading said content, possibly downloaded in the operating layer of the mobile phone, adapted for monitoring in background task the notification of an incoming call to an interface phone application or to a phone server of said layer and for activating the reading of said content upon notification of an incoming call.

34. Mobile phone adapted for enabling the substantially synchronous reading of at least an audio content and a graphical content upon reception of an incoming call on a mobile phone, wherein it comprises an application for reading the graphical content possibly downloaded in the operating layer of the mobile phone adapted for monitoring in background task the notification of an incoming call to an interface phone application or to a phone server of said layer and for activating the reading of said content upon notification of an incoming call.

35. Method for activating at least one personalization content upon reception of an incoming call on a mobile phone, wherein it comprises the steps consisting in:
downloading at least said content,
automatically placing said content as a favourite intended to be activated upon reception of the next incoming call, this step being performed without intervention of the user in the different configuration menus of the phone.

36. Method for activating an audio content upon reception of an incoming call on a mobile phone, comprising the steps consisting in:
downloading the audio content and an associated graphical animation content,
automatically placing the audio content as a favourite intended to be activated upon reception of the next incoming call, this step being performed without intervention of the user in the different configuration menus of the phone.

37. Mobile phone adapted for allowing the reading of at least one personalization content upon reception of an incoming call on the mobile phone, comprising an application, which upon downloading of said content, automatically places it as a favourite intended to be activated upon reception of the next incoming call, this step being performed without intervention of the user in the different configuration menus of the phone.

38. Method for personalizing mobile phones, comprising the steps according to which:
a user compose a combined content by associating an audio content and a graphical animation content, from contents already present in the phone or which he can download otherwise, by means of an interface application memorized at the operating layer of the phone,
when the audio content is played on the phone upon reception of an incoming call, an application for reading graphical content animation, and if need be for reading also audio content, read the graphical animation content.

39. Mobile phone, comprising an interface application, memorized at the operating layer of the phone, adapted for allowing a user to compose a combined content by associating an audio content and a graphical animation content, from contents already present in the phone or which he can download otherwise, the graphical animation content being intended to be read by a reading application of the phone when the audio content is played on the phone upon reception of an incoming call.

40. Method for allowing the reading of a graphical animation content upon reception of an incoming call on a mobile phone, comprising the steps consisting in:
storing in the mobile phone a graphical animation content as fixed images in native format according to a parametrizable frame rate.

41. Mobile phone adapted to allow the reading of a graphical animation content upon reception of an incoming call, comprising a reading application adapted for displaying in sequence fixed images in native format according to a parametrizable frame rate upon reception of an incoming call.

42. Method for downloading ring tones for personalizing mobile phones, comprising the steps consisting in:
memorizing a file including an audio content and/or a graphical animation content, in encrypted form, at the operating layer of the phone,
upon reception of an incoming call, decrypting the file in random access memory and reading the audio content and/or the graphical content.

43. Mobile phone adapted for allowing the downloading of ring tones for personalizing mobile phones, comprising means for memorizing a file including an audio content and/or a graphical animation content, in encrypted form, at the operating layer of the phone, and a reading application adapted, upon reception of an incoming call, for decrypting the file in random access memory and for reading the audio content and/or the graphical content.

44. Method for downloading and reading an animation content, wherein said content is transferred to the phone in a compressed format and said content is stored in the phone in a decompressed format, said content being read in real time under this format upon reception of an incoming call.
